(19) United States
(12) Patent Application Publication
(10) Pub. No.: US 2016/0264431 A1
(43) Pub. Date: Sep. 15, 2016

(54) PURIFICATION METHOD AND PURIFICATION SYSTEM FOR WATER POLLUTED WITH ACCOMPANYING SUBSTANCES

(71) Applicant: WÄTAS WÄRMETAUSCHER SACHSEN GMBH, Olbernhau (DE)

(72) Inventors: Torsten ENDERS, Marienberg (DE); Kerstin GUTEWORT, Chemnitz (DE)

(21) Appl. No.: 15/028,985

(22) PCT Filed: Oct. 15, 2014
(86) PCT No.: PCT/DE2014/100364

§ 371 Date: Apr. 13, 2016

(30) Foreign Application Priority Data
Oct. 15, 2013 (DE) 10 2013 111 352.4

(51) Int. Cl. C02F 1/04; B01D 1/00; C02F 1/16; C02F 1/00; C02F 1/14

(52) U.S. Cl. CPC C02F 1/048; C02F 1/008; C02F 1/14; C02F 1/16; B01D 1/0035; B01D 1/0058; C02F 2209/006; C02F 2209/02; C02F 2209/38; C02F 2303/10; C02F 2103/007

(57) ABSTRACT

Purification methods for polluted water and a purification system needed to carry out the same. At least one respective evaporation device and at least one condensation region are disposed in a flow channel, and an air flow flows around both. In a humidifier, the air flow is loaded with moisture, and the moisture is condensed out again in the condensation region. The flow channel is a closed circuit.

The invention relates to a purification method for water polluted with accompanying substances and to associated purification systems.

It is generally known to distill liquids wherein these are heated above their boiling points and, by way of subsequent condensation, separated liquids are recovered free of accompanying substances. Methods for sea water desalination, alcohol distillation, and fractional distillation for separating crude oil products are generally known in this regard.

The aforementioned methods are typically designed so as to heat the liquid to be purified above the boiling point by supplying energy and carry out forced cooling after the boiling step, thereby achieving high throughput in the systems. Ultimately, however, the high throughput is achieved at the expense of a high system complexity and energy expenditure.

In the drinking water or process water treatment field, systems are also known that bring the polluted water only to temperatures just below the boiling point.

Several solutions are known that achieve the condensation of purified water by way of targeted humidification and dehumidification of air.

The production of distillate or condensate from salt water is the process most frequently described.

Sea water desalination conducted on a large scale is known, in which large systems are set up and the evaporation process is initiated by way of solar heating. Such systems have the disadvantages that they take up significant land areas, these areas becoming unavailable for other uses, that they come with significant system complexity, are not mobile, and additionally have only low efficiency. A purification capacity of 0.11 to 0.14 l m⁻² h⁻¹ is to be achieved.

Likewise, systems have already been proposed in which the physical effect of evaporating a medium is utilized. In the water treatment field, this is described as so-called multi-effect moist air distillation at ambient pressure in the dissertation by Hendrik Müller-Horst, 2002, Munich TU.

A similar suggestion can be found in DE 43 40 745 A1. A method is proposed for an array composed of a storage receptacle, an evaporation region, and a condensation region, which are located in a shared insulated housing. To achieve a large temperature difference, a solar module is disposed in the media line between the outlet of the condensation region and the inlet of the evaporation region. The air circulation within the insulating housing is to be based on natural convection, which at the same time is the major drawback of this array. Another drawback is that the temperature within the insulating housing cannot be controlled. Control options for the temperature level in the insulating housing exist at best in the magnitude of the temperature increase and via the amount of polluted water that is pumped through the system. No direct influence exists on the temperature of the air in the interior of the housing.

In other proposed solutions, the boiling, evaporation or condensation assemblies are introduced into an absolutely required enclosure or even encapsulation. Energy exchange and phase change of the polluted water can be achieved by way of natural convection with an air current that is typically present, without additional driving energy. Corresponding suggestions can be found in DE 24 59 935 A1, DE 30 10 208 A1, and DE 199 29 212 A1.

In DE 24 59 935 A1, it is proposed to use a blower instead of natural convection, the blower circulating the process air within the enclosed device. Operating the system without using the blower is likewise to be possible. Since an increased flow rate is created for the loaded process air when the system is being operated with the blower, loaded process air finds its way back into the evaporation region of the system. This air must be newly heated, and thus the energetic efficiency of the system decreases.

In some systems, it is assumed that a large difference in temperature is necessary between the cold and warm sides. For this reason, technologically generated cold energy is supplied to the water on the cold side in some systems, or subsequent heating is carried out in the evaporation region by supplying energy from other systems. Such a suggestion can be found in DE 24 59 935 A1. In these systems, it is essential to expend primary energy so as to achieve the necessary energy supply. An operation with renewable energy sources alone is not possible. If the energy to be supplied is to be supplied from excess energy of existing systems, the purification systems are bound to the respective other systems.

In the first case, additional energy thus becomes necessary for operating the blower, while in the second case the mobility of such systems is lost by virtue of being tied to existing other systems and processes.

According to a suggestion in DE 20 2004 017 383 U1, a purification system for polluted water is to be implemented as a compact system having a humidifier operating based on the cross-flow principle. A rotating convection drum is proposed as the humidifier. The system is to be fed polluted water heated by solar energy and is to be supplied with electrical energy via a photovoltaic system and associated rechargeable batteries.

According to a suggestion in WO 95/21130 A1, it is supposed to be possible to operate a stationary purification system using a purification method in which the polluted water and the process air are heated by way of solar energy.

With respect to the use of evaporators, a number of suggestions exist for the design of the same. It is proposed in DE 30 10 208 A1, for example, to provide a nonwoven fabric for the evaporator, which can be heated by way of a heat exchanger associated with the nonwoven fabric.

According to a suggestion in DE 43 40 745 A1, the liquid to be evaporated is said to be able to flow down across woven or nonwoven fabric webs. Due to the absence of suitable additional devices, this can only involve a random, waterfall-like flow. Moreover, it is indispensable to set up the system exactly horizontally during every use.

It is likewise known to use freely suspended cloths, nets or rigid structures made of metal or plastic material.

The above-described solutions always attempt to improve individual properties or the necessary components of the purification systems so that the system and associated method can each be optimized with respect to the proposed properties or units. Other properties, or the units required for creating these, however, are largely disregarded in the process, whereby the optimization effects remain limited. Little importance is attached to the cooperation of all individual components of such purification systems. This applies in particular also to the corresponding procedure, with the goal of achieving the maximum yield of condensate possible.

To the extent these are systems that operate based on the evaporation/condensation method, additionally certain requirements remain without consideration from the outset:
While systems operated with solar heat hold the promise of using renewable energy, it is frequently overlooked that this type of energy is not available 24 hours a day, every day, and the systems can therefore only be used conditionally.
The evaporation of 1 kg water per hour at an evaporation temperature of approximately 80° C. requires approximately 640 watts of power. Heating the water from approximately 30° C. to approximately 80° C. moreover requires an energy expenditure of approximately 60 watts per liter. Added to this is another 14 W per liter of air for heating from 30° C. to 80° C. Thus, to be able to effectively operate purification systems for polluted water, solar-powered systems need enormously large areas for the necessary heating of polluted water and process air. If these types of purification systems are used in regions not close to the equator, availability is reduced even further.
To the extent that humidifiers can reach temperatures that exceed a temperature threshold of 70° C., there is a risk that mineral admixtures will precipitate from the polluted water.
The supplied polluted water has a temperature of up to 30° C. when the purification systems are operated in regions having intensive solar radiation. If the supplied polluted water is advantageously used to cool the condensation region, this results in a limitation of the condensation capacity.

The known large-scale sea water desalination systems are stationary. Purified water is consequently only available at the location of such systems and requires additional means for transport to the users.

To the extent that the implementation of compact systems using solar heating is proposed, these cannot achieve the necessary capacities, requiring such systems to be dimensioned accordingly large and/or installed in multiples.

According to the dissertation by Hendrik Müller-Holst, a compact system having an evaporator surface area of 76 sqm is to be able to deliver a purification capacity of 0.37 lm^{31 2}h⁻¹.

In the aforementioned cases, information is provided concerning a minimum temperature of 75° C., and normally 80° C., in the evaporation region. Operation at lower temperatures is considered ineffective.

To the extent that compact systems have been implemented, the capacity thereof is often only achieved by evaporation temperatures above the boiling temperature of the liquid, which, however, requires energy to be supplied. The necessary volumes of energy are not always available though, and many locations in which such systems are used do not even have sufficient energy sources.

A need therefore exists for compact systems for purifying water, which are mobile, operate with low energy demand, have a high yield in relation to the evaporation surface area, and can therefore be used in all locations. This also includes locations in which solar-powered systems cannot be used.

It is therefore the object of the invention to refine a purification method operating with solar heating, as proposed in DE 43 40 745 A1 and DE 24 59 935 A1, and the purification system associated with the operation of the method, in such a way that: it can be implemented or operated without solar energy; a considerably higher purification capacity is achieved compared to the known methods and systems; the purification systems necessary to carry out the purification method can be designed in a compact, and optionally portable, manner; operation is possible starting at lower working temperatures; and auxiliary energy sources are at most needed to maintain media flows during operation of the purification method and the purification system.

The above object is achieved by a purification method for polluted water having the features of the characterizing part of claim 1 in conjunction with the features of the preamble of this claim. The above object is likewise achieved by a purification system for polluted water having the features of the characterizing part of claim 8 in conjunction with the features of the preamble of this claim. Other independent and dependent claims describe embodiments of the purification method according to the invention and of the purification system according to the invention.

The description hereafter, the exemplary embodiments, and the claims use the terms listed hereafter, which have the following meanings:

Polluted water: is a substance mixture having a liquid phase and a vapor pressure below the prevailing ambient pressure, from which the water fraction can be extracted by way of evaporation and condensation starting at temperatures below the boiling point. It is, in particular, a mixture of water and accompanying substances of various types.

Reservoir: is an arbitrary receptacle containing the polluted water.

Condensation region: is a device containing technical means that have a lower temperature than the temperature of a gaseous medium and therefore cause a condensation process on the outside of the region, or of the technical means belonging to this region.

Collection device: is a device that receives condensate accumulating on the outside of the means forming the condensation region and discharges the same from the condensation region via a line.

Condensate receptacle: is an arbitrary receptacle in which condensate discharged from the condensation region is collected and kept available for further use.

Heating device: is a device that allows liquid medium coming from the condensation region to be heated, and the vapor pressure of the medium to be consequently raised.

Water distributor: is a device used to supply the heated polluted water, distributed in the form of drops, to a humidifier.

Humidifier: is a device in which liquid medium supplied from the heating device is distributed superficially and evaporates to a greater degree due to the increased vapor pressure of the liquid medium.

According to the invention, a purification method for polluted water is proposed, which operates by way of a system that is at least composed of a pumping device for polluted water, a condensation region, a condensate receptacle, a heating device, and an evaporation region. The system furthermore includes a ventilation channel, which connects the evaporation region and the condensation region to each other and allows for an air current moved by a blower. The listed components are designed so that they can cooperate in an operation having a lower temperature difference than is customary. The necessary energy supply, in the heating device for example, preferably takes place via forms of renewable energy or via excess energy from processes that do not form part of the method.

According to the invention, in particular, a closed housing is implemented. At least the condensation region, the evaporation region including a water distributor, a blower, a partition between the condensation and evaporation regions, and collection options for condensate and dripping polluted water are located within this housing.

The closed housing can be provided with thermal insulation.

It is also possible to dispose the heating device within the closed housing.

Due to the internal partition disposed in the housing and the thermal conditions that result when the purification method is being carried out, an upwardly directed air current is created in the evaporation region, and a downwardly directed air current is created in the condensation region, and thus there is a constantly moving air flow.

Only the polluted water flows through the devices listed at the outset, which are connected to each other. The air flow flows through or around the aforementioned devices as a carrier medium. A second medium, this being the purified medium, accumulates only in the condensation region. All media cooperating with each other operate under atmospheric pressure conditions, whereby special technical expenditures can be dispensed with.

Auxiliary energy may only be necessary to maintain the current of the polluted water and to maintain the loaded air flow. The energy demand is so low that the necessary currents can be achieved with the aid of portable energy-generating units, such as emergency power generators, solar cell stations, rechargeable battery stations or by direct driving using internal combustion engines. It is even possible to intermittently operate the blower and pumping device manually.

The above-described components can be designed so that they, forming the overall system, are adapted to the customary loading dimensions for road haulage or railway transport and thus the overall system is transportable. Even smaller embodiments are likewise conceivable.

To the extent possible, the above-described individual regions of the purification system are operated according to the purification method according to the invention so that the peak temperature of the polluted water does not exceed 85° C. This allows the polluted water to be heated in a heating device by way of solar energy.

In another embodiment, as the polluted water, there is the option to utilize process waste heat, for example, this process waste heat being available at a temperature below the boiling point of the water. In this case, no additional heating energy is required.

The method steps described hereafter take place simultaneously with, and parallel to, each other when the system operates in continuous mode.

According to the purification method according to the invention, the cold polluted water is initially delivered into the condensation region by way of a pumping device. The condensation region is a heat exchanger, which withdraws amounts of heat from a heated air flow and, for this purpose, is cooled by the liquid flow to the lower temperature of the supplied polluted water, so that the purified liquid particles entrained in the air to be cooled can be condensed out on the surface of the condensation region and collected. By way of a line, the condensate can be supplied to a condensate receptacle, where it is available for further uses.

After flowing through the condensation region, the polluted water is supplied to a heating device, where it is heated to a temperature of approximately 85° C.

The heated polluted water is conducted via a line to the evaporation device, where it is distributed in the form of drops across the surface of the evaporation device and, by virtue of its own weight, falls downward.

Effective evaporation takes place in the evaporation region, wherein the evaporated amount is dependent on the temperature of the polluted water, the temperature of the ambient air, the temperature of the evaporation region, and the velocity of the air flow.

In the evaporation region, the falling water drops impinge on an obstacle, whereby the existing free fall is decelerated. The obstacle is a lattice-like structure, the dimensions of which are selected so that no falling drop can freely pass through. Moreover, the structure is selected so that the impinging drops adhere to the lattice-like structure and, due to the adhesion and surface tension thereof, hang on parts of the structure. At the same time, the retaining force for the water drops is greater than the weight of the same. When a certain drop size is exceeded, the equilibrium is unsettled, and the water drops falls off the structural element.

The movement of the water drops is set to a range of less than 10 cm s⁻¹ by design measures within the lattice-like structure, wherein a velocity of 7.5 cm s⁻¹ has been found to be advantageous.

Generally, an excess of water is used in the evaporation region, so that excess amounts of water can drip off at the lower end of the evaporation region and can be collected and returned to the reservoir.

According to the purification method according to the invention, the air flow is used to transport the evaporated liquid from the evaporation region to the condensation region. Additionally, temperature control of the flowing air can be used to achieve a large temperature difference of the air flow compared to the surface temperature in the condensation region.

It is therefore an essential feature of the purification method according to the invention that the air flow always has a high temperature. So as to minimize any heat loss that occurs, the air flow is moved in a closed circuit. This has the advantage that only the amounts of heat withdrawn by virtue of the process in the condensation region must be returned to the air flow in the evaporator.

If significant capacity losses were to be tolerated, it would also be possible to operate with an open flow channel. It would thus even be possible to extract water purified solely from atmospheric moisture, without a reservoir of polluted water.

This design of the purification method makes it possible to use the respective optimal means, both in the evaporation region and in the condensation region, and to adapt these to the method so that they operate with maximum effectiveness.

The temperature difference necessary for the method can also be influenced by way of the flow velocity of the air, which is to say by way of the air volume per unit of time.

It is an essential element of the purification method according to the invention that the amount and temperature of the air flow can be regulated. It is likewise essential that the air flow is maintained in circulation. In any case, this is not a disadvantage when the purification method is used to purify water, and solely the amount of condensate per unit of time is decisive for the effectiveness of the purification method. Since heating takes place by way of energy available elsewhere, no disadvantages arise with respect to energy usage.

The purification system according to the invention combines the components already mentioned in the description of the purification method, which is the reservoir, pumping device, condensation region, heating device, and evaporating device, with each other. The evaporation device/humidifier and the condensation region are components of the purification system that can also be disposed in a ventilation channel.

A line connects the reservoir of polluted water to the pumping device, which in turn delivers the polluted water via a line to the condensation region disposed in the ventilation channel. Additionally, the water is also delivered in the direction of the heating device and the water distributor.

The condensation region is substantially an air/water heat exchanger comprising a surface that has a relatively low temperature to condense out water contained in the passing air flow. For this purpose, the condensation region or the heat exchanger is designed so that moisture condensing out on the surface thereof can easily drip off, following gravity, and be captured with the aid of a collection tray, flow into the condensation receptacle via a line connection, and kept available there for further use. At least up to the condensation region, the temperature of the polluted water corresponds substantially to the temperature present in the reservoir. The air flow passing around the condensation region, however, was heated in the evaporation device. When the heated air flow flows through the condensation region, it must necessarily give off moisture due to the temperature difference. The condensation heat released in the process preheats the polluted water.

The heating device forming part of the system is used to heat the polluted water to a higher temperature after it has flown through the condensation region. It is sufficient if the polluted water is heated to an overtemperature with a value of at least 50° C., and more preferably to 85° C., but not above the boiling temperature of the water.

The evaporation device/humidifier is disposed coaxially in the ventilation channel. It is supplied with heated polluted water from the heating device.

The evaporation device is a body having a large surface area and increased flow resistance, preferably resulting in intensive turbulence in the air taken in, and thus in intensive

contact between the air and the water.

The preferred form of the evaporation device is a lattice-like structure, which is designed so that no free passage exists for falling water drops. The structure is acted upon by free-falling water drops from above, which initially impinge on the lattice-like structure, then hang in the structure in a drop or lens shape, until the developing drop detaches due to the dead weight thereof and then falls further downward. The lattice-like structure is designed to implement a resulting flow rate of less than 10 cm/s. Lower flow velocities increase the residence time and thus also the degree of evaporation relative to a single water drop.

Other embodiments of the evaporation device can operate according to the principle of a wet cooling tower for the polluted water and forced ventilation.

Further preferred embodiments can operate by way of a superficial distribution of the polluted water on textile sheet materials, wherein these, in turn, can preferably be pleated so as to achieve a large surface area, or implemented as a coarse-mesh sheet material, as a knitted spacer fabric, as a net, or as hanging threads or twines.

The distribution of the heated polluted medium preferably takes place on the outlet side of the evaporation device.

It is advantageous if the evaporation device is a body, which under continuous operation of the purification system, quickly takes on the temperature of the inflowing polluted water and thus ensures a high degree of evaporation.

The above-described system can be modified as a function of specific usage conditions.

If the purification system according to the invention is used on a coast or a body of standing or flowing water, the body of water can form the reservoir. The purification system can then, for example, be located directly in the water or be supplied via a feed line.

The pumping device can be designed for manual operation in usage locations where no forms of auxiliary energy are available.

The ventilation channel can be designed so that lift is created by the heating of the air in the evaporation device, and the air current thus starts on its own.

So as to achieve this, the first section of the ventilation channel can preferably be disposed vertically.

The heating device can operate with solar heating, so that no system-external amounts of heat or forms of auxiliary energy are necessary for heating the polluted water.

The purification system can have a compact design, so that it is mobile and can be transported using vehicles.

It is possible to design the purification system so that it can be implemented in container dimensions.

With an appropriate configuration of the ventilation channel, this channel can assume the function of the condensate collection tray in the condensation region.

If the purification system is connected to a line network, the condensate receptacle can be dispensed with.

If a control device is associated with the purification system, operation with high effectiveness, which is to say condensation capacity, is ensured. Depending on the respective requirements, important measuring values are recorded within the purification system and processed by the control device.

The control device can compile the necessary control variables by comparing actual to desired values, sampling permissible value ranges and comparing these, or else by applying predefined algorithms, and can transmit these to the system components to be controlled.

It is likewise possible to store a program in the control device, which assumes the fully automatic control of the purification system.

Preferably a controlled variable is generated for the heating capacity of the heating device, wherein this may also be minimized with a view to energy savings.

It is also possible to generate a controlled variable for the blower, since the amount of evaporated water, and thus the condensation capacity, can also be determined by way of the flow velocity of the air flow.

Further control options include the amount of polluted water that is supplied, or the distribution pattern of the water distributor.

The control device can take all these influencing variables into consideration in an appropriate manner.

In a further embodiment of the purification system, optionally heated process water may be used. This is possible, for example, when water in industrial plants, which has become polluted as a result of the processes to be carried out there, is available at temperatures in the range below the boiling point. In this case, the heating device can be dispensed with. The condensation region is then not connected to the circuit of the polluted water to be purified, but is solely a cold water rinsing circuit.

The invention will be described in greater detail hereafter based on certain exemplary embodiments and drawings. In the drawing:

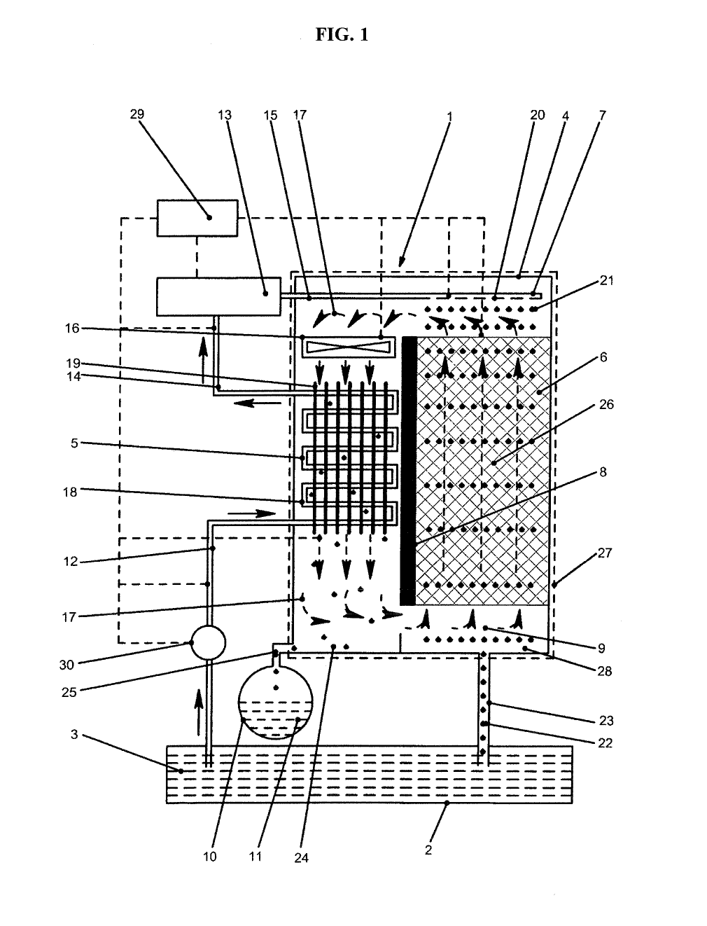

FIG. 1: shows a schematic illustration of the purification system according to the invention.

The purification system 1 according to the invention consists essentially of the main components listed hereafter. A reservoir 2, from which polluted water 3 can be supplied, a housing 4, which a condensation region 5, a humidifier 6, a water distributor 7, a partition 8, a flow channel 9 leading through the humidifier 6 and the condensation region 5, a collection receptacle 10 for purified water 11, and a collection receptacle 28 for dripping residual water 22, which are combined to form one unit. Furthermore, a line 12, which supplies the polluted water 3 to the condensation region 5, and a heating device 13 are needed to operate the purification system 1, wherein the heating device 13 is connected via a line 14 to the condensation region 5 and, via a line 15, to the water distributor 7. A blower 16, which circulates the air flow 17 at a speed that is optimal for the purification method, in the flow channel 9, is another essential component of the purification system 1.

Even though the work steps described hereafter are described consecutively in the following description for reasons of clarity of illustration, they are usually carried out simultaneously, in the purification system 1.

The purification method according to the invention includes supplying polluted water 3 via the line 12 to the condensation region 5 of the purification system 1. Depending on the place of installation of the purification system 1, the temperature of the polluted water 3 can take on values of more than 30° C., as is the case in hot and dry regions of the earth, for example.

In the ventilation channel 9, an air flow 17 is circulated, which is heated to an operating temperature close to the boiling temperature of the polluted water 3 by way of the heating device 13 and the heated polluted water 3 supplied via the line 15 to the water distributor 7. This air flow is kept in motion with the aid of the blower 16.

In the most favorable case, the purification system 1 thus operates at a temperature difference between the polluted water 3 and the air flow 17 of up to 80° C., and in less favorable cases at a temperature difference of as little as 5° C. So as to achieve maximum capacity results, the purification system 1 is thus optimized for an operation at a temperature difference of approximately 40° C., wherein larger temperature differences further increase the capacity.

The polluted water 3 flows via the line 12 into the lower region 18 of the condensation region 5. This region of the condensation region 5 thus has the lowest temperature in the condensation region 5, and within the entire housing 4. The supplied polluted water 3 is heated when it flows through the lines of the condensation region 5 since it takes up amounts of heat from the air flow 17. At the upper end 19 of the condensation region 5, the polluted water 3 thus already has an elevated temperature. The polluted water 3 is supplied via the line 14 to the heating device 13 and is heated therein to a temperature close to the boiling temperature by amounts of heat originating from external energy sources. Preferably, amounts of heat from process heat, which generally develop as lost heat in technical processes, are supplied to the heating device 13. For example, such heat sources can be waste heat from technical processes carried out at an elevated temperature, lost heat from the operation of internal combustion engines and electric motors, compressors, co-generation plants, waste heat from electric transformers, electrical storage devices or geothermal heat. It is likewise possible to use solar heating if other energy sources are not permanently available and limitations on the availability of the purification system 1 can be tolerated.

The polluted water 3 heated in the heating device 13 to a high temperature is supplied via the line 15 to the water distributor 7. Via openings 20, the water distributor 7 gives off the heated polluted water 3 in drop form, wherein the drops 21 fall downward by virtue of the weight thereof and impinge on obstacles 26 in the humidifier 6 which initially retain them. The obstacles 26 are configured so that they offer only a very small contact surface for the drops 21. This means that the contact surface for the drops 21 is dimensioned in such a way that the retaining force slightly exceeds the weight of the drops 21. The developing drops consequently hang on the bottom side of the obstacles 26, whereby they have a comparatively large surface area and can evaporate by way of this.

The air flow 17 circulating in the housing 4 takes up the evaporating amounts of water in the humidifier 6 by entering the humidifier 6 from beneath, flowing through the same, and exiting the same again at the upper end, wherein the air flow 17 upon exiting the humidifier 6 has a moisture content of close to 100%, and ideally also has a temperature close to the boiling point of the water.

During continuous operation of the purification system 1, an equilibrium thus develops in the air flow 17, which is such that the temperature of the air flow 17 takes on a high value, and the moisture takes on a value close to 100%. The actually resulting values are initially determined by the magnitude of lost heat that occurs in the purification system 1. So as to mitigate this, the housing 4 is provided with insulation 27.

During operation of the purification system 1, the condensation region 5 is the region having the lowest temperature, since it is constantly supplied with polluted water 3 having a lower inlet temperature. Due to the temperature differences in the region of the lines and the collection tray 24 of the condensation region 5 designed as a heat exchanger, condensing water droplets form on the surface of the same. These droplets move downward until they drip off in the lower region 18 of the condensation region 5 by virtue of the size and dead weight thereof,

are collected in a collection tray 24, discharged via a line 25, and supplied to the collection receptacle 10 as purified water 11.

The purification method is thus based on the formation of a state of equilibrium in the interior of the housing 4, which is unsettled by the polluted water 3 supplied at a lower temperature, and, as a result of this unsettling of the equilibrium, creates a falling air movement in the condensation region 5. This movement, in turn, results in an upwardly directed air current in the humidifier 6.

Another unsettling source for the developing equilibrium is the water distributor 7, via which amounts of heat are supplied via the drops 21 that are given off.

According to the invention, the process, which continually strives to achieve an equilibrium, is additionally unsettled by bringing about forced circulation of the air flow 17 with the aid of the blower 16.

It is essential to the invention that the operating parameters of the purification system 1 are recorded by way of a control device 29, and that control signals for operating the blower 16 are ascertained from the obtained measured values. In the simplest case, for example, the amount of purified water 11 created per unit of time can be recorded and, based on previously empirically ascertained results, a control variable for the blower 16 can be generated by way of a comparison between the various operating parameters and the amount of purified water 11 per unit of time.

The invention thus takes into consideration that the result of the method according to the invention must be a maximization of the amount of purified water 11 to be obtained.

The control device 29 can be designed to adhere to an operating point that has been found to be optimal, or to an operating pattern that has been found to be optimal.

It can operate in such a way that further external influences on the purification system 1 are considered in the control. This may be the temperature of the polluted water 3, the available amounts of heat for the heating device 13, or the lost heat of the residual water 22 exiting the circuit, which is returned to the reservoir 2 via a discharge line 23.

Known stationary purification systems having solar heating achieve purification capacities of approximately 0.14 l m⁻³ h⁻¹, improved systems achieve purification capacities of approximately 0.4 l m⁻³ h⁻¹. Due to the optimized components and the optimized operating parameters, the system according to the invention achieves a purification capacity of up to 42 l m⁻³ h⁻¹, based on a system volume of 1 m³ and a flow temperature of the polluted water 3 in the water distributor 7 of 80° C. An experimental design of the purification system 1 according to the invention has a volume of 0.75 m³ and a weight of only 75 kg. Within 24 hours, it supplies 750 liters of purified water 11. It is therefore also possible to install and operate systems that have smaller dimensions, which require only 0.75 m² of space, for example, have a low weight, can be transported on a car trailer, and have only a low need for heat. They can be installed in many locations in which waste heat is available for operating the purification system 1.

Preferred uses are the operation in conjunction with internal combustion engines used for electrical energy generation, wherein the waste heat of the same is utilized. Uses also include the usage with heat sources that generate waste heat when technical processes are carried out, which otherwise would become lost heat.

The low space requirement of the purification system 1 according to the invention additionally allows uses that previously were not possible with known systems.

These include, for example, installation in the engine room of a ship, using the waste heat of the ship's engine, in buildings, using the waste heat of air conditioners, cooking equipment, drying and washing appliances, or industrially used heat sources or the waste heat thereof.

The compact purification system 1 can be used for autonomous water supply if a sufficiently large reservoir 2 is associated with it and there is the option to use at least the reservoir 2 to again lower the temperature of the polluted water 3 therein.

In addition to the small systems as described, the purification systems 1 according to the invention can also be implemented in considerably larger designs with at least identical parameters when the necessary amounts of heat are available at the place of installation. It is thus possible to combine the purification systems with large-scale processes in crude oil processing, in power generation, in the generation of cold energy, and similar processes.

In any case, multiple installations of the purification system 1 and the simultaneous operation thereof is also possible.

The purification system 1 according to the invention is configured to be suitable for carrying out the purification method according to the invention. Accordingly, it is composed of the main components already mentioned above, these being the humidifier 6, the condensation region 5, a heating device 13, and the water distributor 7. Furthermore, a collection receptacle 10 for the accumulating purified water 11 may be part of the purification system 1.

According to the invention, the flow channel 9 is a closed channel. This means that the air flow 17 present in the flow channel 9 is located in a circuit.

In a first section, the flow channel 9 has a substantially vertical orientation and accommodates the humidifier 6. This means the flow channel surrounds the same.

The humidifier 6 can take on a variety of designs. In any case, it acts in such a way that the polluted water 3 comes in contact with the air flow 17, so that an evaporation process of the polluted water 3 begins.

The humidifier 6 can be a single component, which has a particularly large surface.

The humidifier 6 can be a pleated, rolled-up or cockled textile sheet material. It can likewise be a similar structure made of felt, a fiber structure, or nonwoven fabric. Other options exist in the use of knitted fabrics, especially knitted spacer fabrics, or lattice-like or net-like sheet materials.

Other options exist in the arrangement of Individual threads or twines, which may be arranged with a high packing density.

Furthermore, the humidifier 6 can be a three-dimensional lattice-like structure made of plastic material, metal or vitreous materials, or made of a metallic structure. In a preferred embodiment, it can be a pile of metal swarfs.

Other options exist in the use of nonwoven fabric, felt, cellulose glass or polymer fibers, so-called fillers made of ceramic, plastic materials or metals, or in a layered arrangement, in which multiple collection trays disposed on top of each other regularly overflow and thus enable constant dripping of the polluted water 3.

The preferred embodiment of the humidifier 6 is a lattice structure comprising lattice elements having such a small diameter that impinging water immediately forms hanging drops. The retaining force of the lattice elements is only slightly higher than the weight of the drops that form. As the drop size increases, these detach, fall, and collide with further lattice elements, so that the process is repeated. The speed of the water drops achieved when they pass through the lattice structure is a maximum of 0.1 m s⁻¹, or even considerably less if the lattice structure is optimally designed.

According to a simple embodiment of the humidifier 6, additional installations are entirely dispensed with, and instead a water distributor 7 is provided, which sprays the polluted water 3, wherein the developing drops 21, as in the above-described embodiments, fall downward by virtue of the weight thereof.

So as to expedite the evaporation process, the polluted water 3 is heated in a heating device 13 to a high temperature, which, however, remains below the boiling point of the polluted water 3. It is not relevant for the invention in what way the amounts of heat required for heating the polluted water 3 are generated, and how they are introduced into the polluted water 3.

In the humidifier 6, the air flow 17 is loaded with moisture.

Due to the high temperature of the polluted water 3, the air flow 17 is also heated, whereby an upwardly directed air flow is created in the flow channel 9.

A second section of the flow channel 9 again has a vertical orientation. The condensation region 5 is disposed in this section, wherein this is preferably designed as a heat exchanger. It is immaterial for the essence of the invention which embodiment of a heat exchanger is selected.

An insulating partition 8 is disposed between the humidifier 6 and the condensation region 5.

The condensation region 5 is flushed with cold polluted water 3 via the line 12, so that the condensation region 5 at the lower region 18 thereof has a surface temperature that approximately corresponds to the temperature of the supplied polluted water 3.

Consequently, a considerable difference in temperature of at least 10° C., but preferably up to 85° C., exists between the incoming loaded air flow 17 and the lower region 18 of the condensation region 5.

The moisture transported by the air flow 17 condenses out on the surface of the condensation region 5, drips off the surface, and is collected by way of a collection receptacle 24, supplied to a line 25, and collected as purified water 11 in the collection receptacle 10.

The condensation region 5 can be improved in a variety of ways. For example, a finned tube heat exchanger can be used, the fins of which have a vertical orientation. Furthermore, a fin distance can be selected which precludes a bridge formation by water drops between two neighboring fins.

The use of fins having a surface coating that increases the flow rate of adhering water is particularly preferred. This may be a plastic coating.

The above-described purification system 1 can be further configured in a variety of ways.

A connection to a natural water reservoir or to a body of flowing water, from which the polluted water 3 is then withdrawn, can be established via the line 14.

It is possible to deliver the liquid current of the polluted water 3 by way of a pumping device 30.

A preferred embodiment of the purification system 1 provides a dedicated reservoir 2 for the same, in which the polluted water 3 is filled.

The reservoir 2 can be disposed beneath the humidifier 6, and dripping polluted water 3 can thereby be recovered.

It is furthermore possible to insulate the line 12 to ensure a low temperature of the polluted water 3, to install the same deep in the ground or keep it so short that no noteworthy heating of the polluted water 3 can take place in the line 14.

The reservoir 2 or an additional receptacle can likewise be arranged in the ground so as to keep the temperature of the polluted water 3 low.

The heating device 13 can be designed so as to heat the polluted water 3 by way of solar energy. It can likewise be heated with amounts of heat from the combustion of fossil fuels or using electric energy or using lost energy from processes not associated with the purification system.

If sufficient solar energy is available, the heating device 13 can be designed as a solar collector, or one may be associated therewith.

This solar collector may furthermore be partially coverable and thereby allow the heating capacity to be controlled. It may be regulatable as a function of the outlet temperature of the polluted water 3 in the line 15 during the transition to the humidifier 6.

A particularly preferred embodiment of the purification system 1 provides for the use of a powerful solar collector as the heating device 13 and connection of a plurality of humidifiers 6 downstream of the same, which in turn operate with a plurality of condensation regions 5 and thus allow several similar purification systems to be cascaded.

Likewise, an embodiment of the purification system 1 can provide for a plurality of condensation regions 5 to be connected downstream of a humidifier 6.

The humidifier 6 can take on a wide variety of designs.

An evaporation body is preferred, which is supplied via the water distributor 7 with drops 21 of heated polluted water 3.

To the extent that excess amounts of polluted water 3 occur, these can drip into the reservoir 2 if the humidifier 6 is appropriately arranged.

Other embodiments of the humidifier 6 can be implemented without the evaporation body by spraying the polluted water 3 via a water distributor 7 connected downstream of the line 15. The air flow 17 is in a counterflow to the flow of droplets, which falls downward by virtue of the weight of the individual droplets.

It is possible to control the blower 16 as a function of measured variables of the purification system 1, such as the inlet temperature of the polluted water 3, the temperature of the polluted water 3 in the line 15, the temperature of the air flow 17, or the amount of discharged purified water 11.

The same control options exist with a pumping device 30, which can be arranged for delivery of the polluted water 3.

A preferred embodiment of the purification system 1 is furthermore created when an additional storage tank for heated polluted water 3 is provided in conjunction with an oversized heating device 13, which can be designed as a solar collector. An excess supply of heated polluted water 3 can then be temporarily stored and is available again, for example after

sundown, to continue the operation of the purification system 1.

Another preferred embodiment of the purification system 1 can dispense with the arrangement of a heating device 13. In this case, the purification system 1 is supplied directly with process water as the polluted water 3 from systems or methods that are not part of the invention. This makes it possible to render usable amounts of energy that otherwise would be lost, in addition to generating purified water.

Finally, when only solar heating is used, the purification system 1 can be designed in such a way that it does not need outside energy, except for the operation of a pumping device 30 and the blower 16, and optionally any measuring and evaluation devices that need to be supplied.

With suitable dimensioning, the purification system 1 can be designed to be mobile, vehicle-mounted, or have a compact design for small consumers.

The invention thus has the advantage that, by incorporating waste heat of technical processes or natural, renewable, energy sources, it makes it possible to implement a purification method for polluted water operating under normal pressure, and a purification system suitable for carrying out the method, which supplies an amount of purified water 11 that is several times greater than that of previously known purification systems and the methods thereof, at the same size.

### LIST OF REFERENCE NUMERALS

1 purification system
2 reservoir
3 water
4 housing
5 condensation region
6 humidifier
7 water distributor
8 partition
9 flow channel
10 collection receptacle
11 water
12 line
13 heating device
14 line
15 line
16 blower
17 air flow
18 region
19 end
20 opening
21 drop
22 residual water
23 discharge line
24 collection receptacle
25 line
26 obstacle
27 insulation
28 collection tray
29 control device
30 pumping device

1. A purification method for water polluted with accompanying substances in a purification system, comprising:
an option for supplying polluted water;
a pumping device;
a condensation region;
a collection receptacle;
a heating device;
a water distributor;
a humidifier;
a first line by which the polluted water can be delivered to the condensation region, the heating device and the humidifier by way of the pumping device;
a line by which the condensation region is connected to the collection receptacle;
and a flow channel, which at least connects the humidifier and the condensation region to each other;
a blower; and
a control device,
wherein the aforementioned installations interact with each other in such a way that:
the polluted water is supplied to the condensation region by way of the pumping device, whereby the surface temperature of the same adapts to the media temperature of the polluted water;
the polluted water takes up amounts of heat when flowing through the condensation region;
the polluted water subsequently flows through a heating device, where it takes up additional amounts of heat, wherein:
the polluted water circulating in the first line is heated beyond the intrinsic temperature thereof in the heating device so that it has an increased evaporation tendency when entering the humidifier;
the polluted water is subsequently delivered to the humidifier and distributed, and comes in close contact with an air flow, whereby it at least partially evaporates;
an air flow forms in the flow channel, which flows through the humidifier and is loaded with an evaporating fraction of the polluted water;
the loaded air flow flows through the condensation region and is subsequently returned in the flow channel to the humidifier, wherein the condensation region has a lower temperature than the air flow so that purified liquid is able to condense out, and the same is collected and returned via a line to the collection receptacle,
wherein
the temperature of the polluted water flowing in the first line section at a minimum corresponds to the temperature of the supplied polluted water at the inlet of the condensation region, and at a maximum corresponds to the boiling temperature of the same at the outlet of the heating device,
wherein;
the control device controls the purification method in such that the largest possible amount of purified water per unit of time is ascertained from measured variables ascertained in the purification system, and that the flow velocity of the air flow required for this purpose is set.

2. The purification method for water polluted with accompanying substances according to claim 1, wherein the control device, in a storage region, includes data for the respective optimal operating patterns within established starting conditions, and the control variables for the blower are generated by comparing the measured data to stored data.

3. The purification method for water polluted with accompanying substances according to claim 1, wherein the control device includes a storage region in which characteristic maps for parameter ranges are stored, and characteristic control variables for the blower and/or the pumping device are generated according to algorithms stored in the storage region.

4. The purification method for water polluted with accompanying substances according to claim 1, wherein in an additional work step, the temperature at the outlet of the heating device is recorded, and when a limit value near the boiling temperature of the polluted water is reached:
the delivery capacity of the pumping device is increased and/or the heating capacity of the heating device is decreased and/or a sub-flow of the heated polluted water is supplied to a storage device.

5. The purification method for water polluted with accompanying substances according to claim 1, wherein the polluted water is withdrawn from a natural water reservoir and/or a reservoir and/or a storage device and/or a process water circuit.

6. The purification method for water polluted with accompanying substances according to claim 1, wherein the amounts of heat required for operating the purification system are withdrawn from an external geothermal or solar heat source, or the waste heat from heat generators, internal combustion engines, heat generators, or industrially generated waste heat.

7. The purification method for water polluted with accompanying substances according to claim 1, wherein the unloaded air flow in a subsequent work step flows at least through a further purification system.

8. A purification system for polluted water for carrying out a purification, comprising:
an option for supplying polluted water;
a pumping device;
a condensation region;
a collection receptacle;
a heating device;
a water distributor;
a humidifier; and
a first line by which the polluted water can be delivered to the condensation region, the heating device and the humidifier by way of the pumping device;
a line by which the condensation region is connected to the collection receptacle;
and a flow channel, which at least connects the humidifier and the condensation region to each other at the outlets and inlets thereof; and
a blower, which is disposed in the ventilation channel,
wherein:
a control device is disposed in the purification system, which includes a storage region and, stored therein, parameters and/or parameter ranges and/or algorithms, which can be used to control the blower or the pumping device.

9. The purification system according to claim 8, wherein the flow channel is disposed substantially vertically in the region of the humidifier and in the condensation region.

10. The purification system according to claim 8, wherein a reservoir is associated therewith.

11. The purification system according to claim 8, wherein the heating device can be heated by solar energy and/or geothermal energy and/or using fuels and/or using electric energy and/or using lost energy of technical processes.

12. The purification system according to claim 8, wherein the humidifier is an inherently stable evaporation body that can be irrigated.

13. The purification system according to claim 8, wherein the evaporation body is a metallic, vitreous or ceramic body, a plastic body, a pile of water-resistant fiber materials, a felt, a textile sheet material, a lattice, a three-dimensionally shaped lattice structure, a net, a knitted fabric, an arrangement comprising a finite number of suspended webs and/or strips and/or threads and/or twines.

14. The purification system according to claim 8, wherein the line or the line has an option for feeding polluted heated process water of external devices.

15. The purification system according to claim 8, wherein the reservoir is disposed beneath the humidifier.
